(19) United States
(12) Patent Application Publication
(10) Pub. No.: US 2026/0189854 A1
(43) Pub. Date: Jul. 2, 2026

(54) Speaker

(71) Applicant: AAC Microtech (Changzhou) Co., Ltd., Changzhou City (CN)

(72) Inventors: Zhizhu Chen, Changzhou (CN); Zhaoyu Yin, Changzhou (CN)

(21) Appl. No.: 19/337,817

(22) Filed: Sep. 23, 2025

Related U.S. Application Data
(63) Continuation of application No. PCT/CN2024/143863, filed on Dec. 30, 2024.

(51) Int. Cl. H04R 9/06; H04R 7/04; H04R 7/18

(52) U.S. Cl. CPC H04R 9/06; H04R 7/04; H04R 7/18; H04R 2207/021; H04R 2400/11

(57) ABSTRACT

The present application provides a speaker having a frame, a vibration system and a magnetic circuit system. The vibration system includes a diaphragm and a voice coil assembly having a first voice coil and a second voice coil arranged side by side along a first direction and located on the diaphragm. The vibration system further includes a first flexible assembly conducting the first voice coil and the second voice coil, and a second flexible assembly connecting the voice coil assembly and an external circuit. The first flexible assembly and the second flexible assembly are arranged on opposite sides of the voice coil assembly along a second direction perpendicular to the first direction. The speaker of the present application not only improves the utilization rate of magnetic field by the voice coil, but also enhances the magnetic field strength, thereby improving the acoustic performance of the product.

### TECHNICAL FIELD

The present application relates to the field of acoustic-electric technology, particularly to a speaker.

### BACKGROUND

With the development of science and technology, portable electronic products, such as mobile phones, handheld game consoles, navigation devices or handheld multimedia entertainment devices, are widely used in people's daily life. In these mobile electronic devices, voice playback devices are essential internal components, and the quality of voice directly affects the user experience when using these mobile electronic devices. Therefore, the requirements for speakers applied therein are becoming increasingly higher.

The speaker in the related art includes a magnetic circuit system and a vibration system, wherein the vibration system includes a diaphragm and a single voice coil combined on one side of the diaphragm. The voice coil is connected through a bent flexible circuit board to conduct current. When electrified, the voice coil can drive the diaphragm to vibrate under the action of the magnetic circuit system, thereby achieving sound generation of the sound device. However, due to the limited inner diameter size of a single voice coil, the utilization rate of the magnetic field generated by the magnetic circuit system is not high, and it is difficult to improve the high-frequency performance and low-frequency performance of ultra-thin speaker units.

Therefore, it is necessary to provide a product that solves the above problems.

### SUMMARY

The object of the present application is to provide a speaker which can not only improve the utilization rate of magnetic field by the voice coil, but also enhance the magnetic field strength, thereby improving the acoustic performance of the product.

To achieve the above purposes, the present invention provides a speaker, comprising a frame, a vibration system fixed to the frame, and a magnetic circuit system. The vibration system comprises a diaphragm fixed to the frame and a voice coil assembly driving the diaphragm to vibrate and generate sound. The voice coil assembly comprises a first voice coil and a second voice coil arranged side by side along a first direction and located on a side of the diaphragm closer to the magnetic circuit system.

The vibration system further comprises a first flexible assembly fixed to the frame and conducting the first voice coil and the second voice coil, and a second flexible assembly connecting the voice coil assembly and an external circuit; the first flexible assembly and the second flexible assembly are arranged on opposite sides of the voice coil assembly along a second direction perpendicular to the first direction.

The first direction and the second direction are both perpendicular to a vibration direction of the diaphragm, the first flexible assembly comprises two first flexible supports arranged along the first direction and a conductive portion connecting the two first flexible supports; and the first voice coil and the second voice coil are connected in series through the conductive portion.

In addition, each of the two first flexible supports comprises a first elastic arm fixed to the frame, a first supporting part extending and bending from the first elastic arm toward the diaphragm, and a first lead connecting portion extending and bending from the first supporting part in a direction away from the first elastic arm and fixed to the diaphragm; the conductive portion connects the two first lead connecting portions.

In addition, the second flexible assembly comprises two second flexible supports arranged along the first direction, each of the two second flexible supports comprises a second elastic arm fixed to the frame, a second supporting part extending and bending from the second elastic arm toward the diaphragm, and a second lead connecting portion extending and bending from the second supporting part in a direction away from the second elastic arm and fixed to the diaphragm; a solder pad for connecting the external circuit is provided on the second elastic arm.

In addition, the magnetic circuit system comprises a lower plate, two inner magnetic circuit portions connected to the lower plate, and an outer magnetic circuit portion surrounding the two inner magnetic circuit portions; the first voice coil surrounds one of the two inner magnetic circuit portions, the second voice coil surrounds another one of the two inner magnetic circuit portions, and the two inner magnetic circuit portions and the outer magnetic circuit portion jointly form a magnetic gap for receiving the first voice coil and the second voice coil.

In addition, each of the two inner magnetic circuit portions comprises an inner magnet fixed to the lower plate and an inner pole piece covering a side of the inner magnet away from the lower plate, and the outer magnetic circuit portion comprises an outer magnet fixed to the lower plate and an outer pole piece covering a side of the outer magnet away from the lower plate.

In addition, the outer pole piece comprises two first sides extending along the first direction and two first protruding parts extending from the two first sides respectively in a direction away from the voice coil assembly; the two first protruding parts are fixedly connected to the frame.

In addition, the outer magnet comprises two first outer magnetic parts extending along the first direction and arranged on opposite sides of the voice coil assembly, and two second protruding parts extending from the two first outer magnetic parts in a direction away from the voice coil assembly and fixedly bonded to the two first protruding parts.

In addition, the lower plate comprises a lower plate body and a third protruding part extending from the lower plate body in a direction away from the inner magnetic circuit portions; the third protruding part is arranged corresponding to the second protruding part along the vibration direction of the diaphragm and is fixedly bonded to the second protruding part.

In addition, the outer magnet further comprises two second outer magnetic parts extending along the second direction and arranged on opposite sides of the voice coil assembly, and a third outer magnetic part arranged between the two inner magnets with spacing, wherein a length d1 of the second outer magnetic part along the second direction is greater than a length d2 of the third outer magnetic part along the second direction.

In addition, the diaphragm comprises a dome portion and a suspension surrounding the dome portion, wherein the first voice coil and the second voice coil are fixed to the dome portion, the dome portion comprises a bending part extending and bending from an outer edge of the dome portion toward the magnetic circuit system and abutting against the first flexible support, and the bending part is provided with an opening part for avoiding the first protruding part.

By arranging multiple voice coils side by side, the inner perimeter of the voice coils can be effectively increased. Under the same voice coil length (L value), the voice coil wall thickness can be smaller, so the magnetic gap can be narrower, which can effectively enhance the magnetic field strength (B value); meanwhile, multiple voice coils can significantly increase the dome support area, improve dome strength, and achieve the same high-frequency performance with a thinner dome, which is beneficial for miniaturization and thinning of the speaker.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a speaker in accordance with an exemplary embodiment of the present application;

FIG. 2 is an exploded view of the speaker in FIG. 1;

FIG. 3 is an isometric view of the speaker, with a diaphragm thereof removed;

FIG. 4 is a cross-sectional view of the speaker, taken along line A-A in FIG. 1;

FIG. 5 is an isometric view of a first flexible assembly of the speaker;

FIG. 6 is an isometric view of a second flexible assembly of the speaker;

FIG. 7 is an isometric view showing a combination of an inner magnet and an outer magnet of the speaker.

### DETAILED DESCRIPTION OF THE EMBODIMENTS

The following will be taken in conjunction with the accompanying drawings of embodiments of the present invention, The technical scheme in the embodiments of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

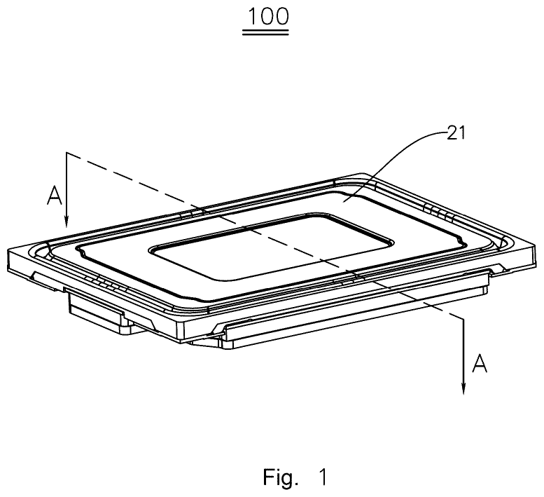

As shown in FIGS. 1-7, the present application provides a speaker 100, comprising a frame 1, a vibration system 2 fixed to the frame 1 and a magnetic circuit system 3, wherein the vibration system 2 comprises a diaphragm 21 fixed to the frame 1 and a voice coil assembly 22 driving the diaphragm 21 to vibrate and generate sound. The voice coil assembly 22 comprises a first voice coil 221 and a second voice coil 222 arranged side by side along a first direction and located on a side of the diaphragm 21 closer to the magnetic circuit system 3.

The vibration system 2 further comprises a first flexible assembly 23 fixed to the frame 1 and conducting the first voice coil 221 and the second voice coil 222, and a second flexible assembly 24 connecting the voice coil assembly 22 and an external circuit, wherein the first flexible assembly 23 and the second flexible assembly 24 are arranged on opposite sides of the voice coil assembly 22 along a second direction perpendicular to the first direction.

The first flexible assembly 23 comprises two first flexible supports 231 arranged along the first direction and a conductive portion 232 connecting the two first flexible supports 231, wherein the first voice coil 221 and the second voice coil 222 are connected in series through the conductive portion 232.

By arranging multiple voice coils side by side, the inner perimeter of the voice coils can be effectively increased. Under the same voice coil length (L value), the voice coil wall thickness can be smaller, so the magnetic gap can be narrower, which can effectively enhance the magnetic field strength (B value); meanwhile, multiple voice coils can significantly increase the dome support area, improve dome strength, and achieve the same high-frequency performance with a thinner dome, which is beneficial for miniaturization and thinning of the speaker.

It should be noted that in this embodiment, both the first direction and the second direction are perpendicular to the vibration direction of the diaphragm.

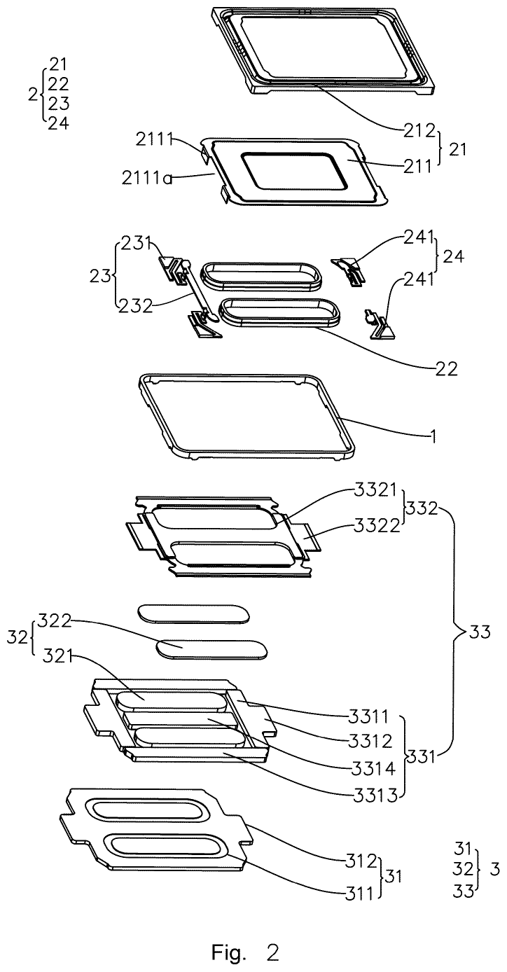

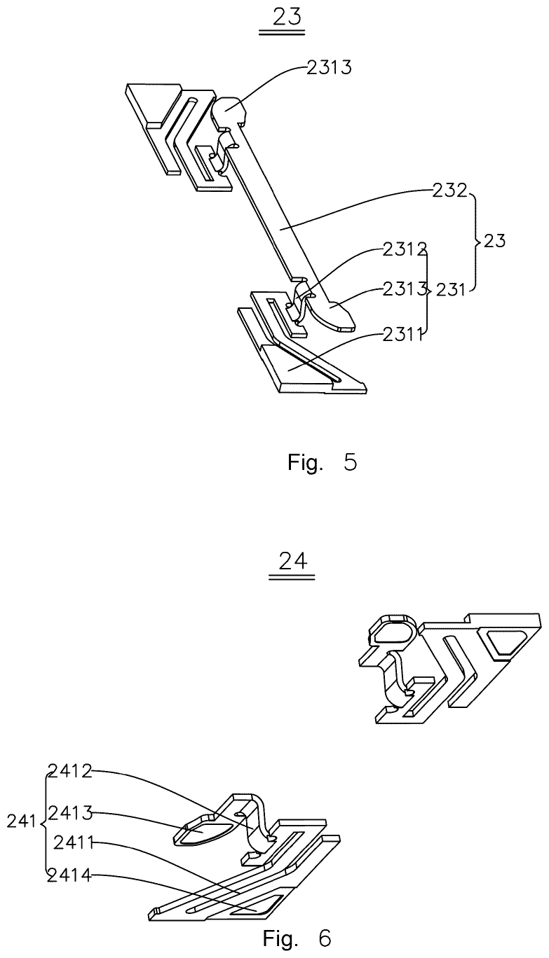

As shown in FIGS. 2 and 5, each of the two first flexible supports 231 comprises a first elastic arm 2311 fixed to the frame 1, a first supporting part 2312 extending and bending from the first elastic arm 2311 toward the diaphragm 21, and a first lead connecting portion 2313 extending and bending from the first supporting part 2312 in a direction away from the first elastic arm 2311 and fixed to the diaphragm 21, wherein the conductive portion 232 connects the two first lead connecting portions 2313.

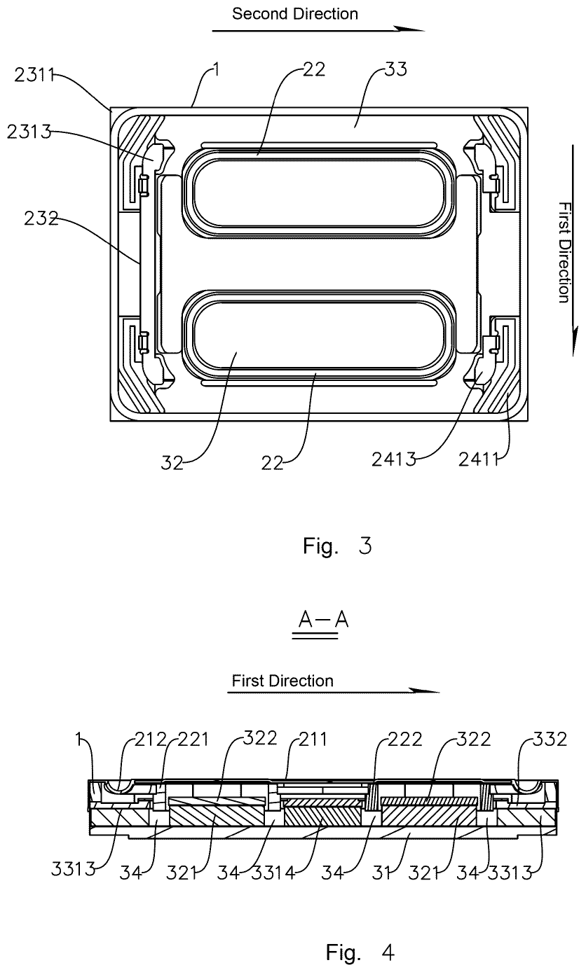

Furthermore, as shown in FIGS. 3 and 6, the second flexible assembly 24 comprises two second flexible supports 241 arranged along the first direction, each of the two second flexible supports 241 comprises a second elastic arm 2411 fixed to the frame 1, a second supporting part 2412 extending and bending from the second elastic arm 2411 toward the diaphragm 21, and a second lead connecting portion 2413 extending and bending from the second supporting part 2412 in a direction away from the second elastic arm 2411 and fixed to the diaphragm 21. As shown in FIG. 6, a solder pad 2414 for connecting the external circuit is provided on the second elastic arm 2411.

As shown in FIGS. 2-4, the magnetic circuit system 3 comprises a lower plate 31, two inner magnetic circuit portions 32 connected to the lower plate 31, and an outer magnetic circuit portion 33 surrounding the two inner magnetic circuit portions 32. The two inner magnetic circuit portions 32 are arranged corresponding to the voice coil assembly 22 and are respectively surrounded by the first voice coil 221 and the second voice coil 222. Specifically, the first voice coil surrounds one of the two inner magnetic circuit portions, and the second voice coil surrounds the other one of the two inner magnetic circuit portions. The inner magnetic circuit portions 32 and the outer magnetic circuit portion 33 jointly form a magnetic gap 34, wherein the first voice coil 221 and the second voice coil 222 are both inserted in the magnetic gap 34. When the voice coil assembly 22 is electrified, the generated magnetic field interacts with the magnetic circuit system 3 to drive the diaphragm 21 to vibrate and generate sound.

As shown in FIG. 4, each of the two inner magnetic circuit portions 32 comprises an inner magnet 321 fixed to the lower plate 31 and an inner pole piece 322 covering a side of the inner magnet 321 away from the lower plate, and the outer magnetic circuit portion 33 comprises an outer magnet 331 fixed to the lower plate 31 and an outer pole piece 332 covering a side of the outer magnet 331 away from the lower plate.

Preferably, as shown in FIG. 2, the outer pole piece 332 comprises two first sides 3321 extending along the first direction and two first protruding parts 3322 extending from the two first sides 3321 respectively in a direction away from the voice coil assembly 22, wherein the two first protruding parts 3322 are fixedly connected to the frame 1. The provision of the first protruding parts 3322 can improve the short-axis strength of the speaker and effectively reduce magnet damage caused by speaker dropping while meeting the requirements for miniaturization and thinning of the speaker.

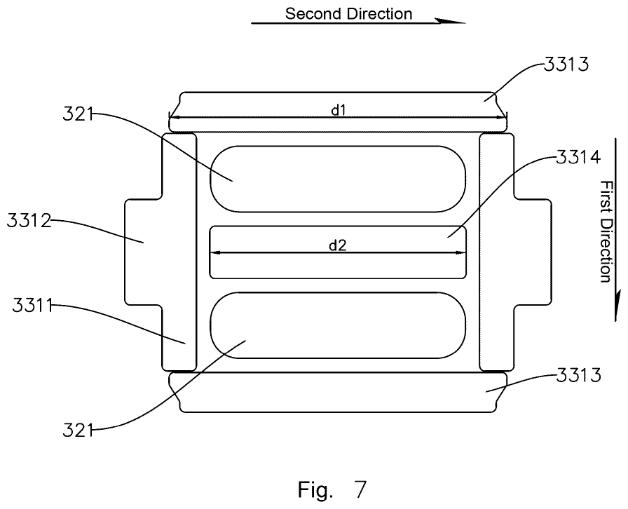

As shown in FIGS. 2 and 7, the outer magnet 331 comprises two first outer magnetic parts 3311 extending along the first direction and arranged on opposite sides of the voice coil assembly 22, and two second protruding parts 3312 extending from the two first outer magnetic parts 3311 in a direction away from the voice coil assembly 22 and fixedly bonded to the two first protruding parts 3322. The provision of the second protruding parts 3312 increases the volume of magnets in the magnetic circuit system, improving the BL value, thereby making the speaker's sound performance more superior.

Furthermore, as shown in FIGS. 2 and 7, the outer magnet 331 further comprises two second outer magnetic parts 3313 extending along the second direction and arranged on opposite sides of the voice coil assembly 22, and a third outer magnetic part 3314 arranged between the two inner magnets 321 with spacing. In this embodiment, the first outer magnetic parts, the two second outer magnetic parts, and the third outer magnetic part are separate magnets. Of course, in other embodiments, the first outer magnetic parts 3311 and the two second outer magnetic parts 3313 can be an integral magnet, or optionally, the first outer magnetic parts 3311, the two second outer magnetic parts 3313, and the third outer magnetic part 3314 can also be an integral magnet, with the second protruding parts 3312 arranged on the integral magnet at positions corresponding to the first protruding parts 3322 along the vibration direction of the diaphragm.

Preferably, as shown in FIG. 7, the length d1 of the second outer magnetic part 3313 along the second direction is greater than the length d2 of the third outer magnetic part 3314 along the second direction.

Furthermore, the lower plate 31 comprises a lower plate body 311 and a third protruding part 312 extending from the lower plate body 311 in a direction away from the inner magnetic circuit portions 32, wherein the third protruding part 312 is arranged corresponding to the second protruding part 3312 along the vibration direction and is fixedly bonded to the second protruding part 3312.

Furthermore, the diaphragm 21 comprises a dome portion 211 and a suspension 212 surrounding the dome portion 211, wherein the first voice coil 221 and the second voice coil 222 are fixed to the dome portion 211. The dome portion 211 comprises a bending part 2111 extending and bending from an outer edge of the dome portion 211 toward the magnetic circuit system 3 and abutting against the first flexible support 231, and the bending part 2111 is provided with an opening part 2111a for avoiding the first protruding part 3322. The provision of the opening part 2111a can make the speaker structure more compact, which is an improvement made to meet the requirements for miniaturization and thinning, and is a preferred embodiment of the present application.

Compared with the related art, the speaker of the present application, by arranging multiple voice coils side by side, can effectively increase the inner perimeter of the voice coils. Under the same voice coil length (L value), the wall thickness can be smaller, so the magnetic gap can be smaller, which can effectively enhance the magnetic field strength (B value); meanwhile, multiple voice coils can significantly increase the dome support area, improve dome strength, and achieve the same high-frequency performance with a thinner dome, which is beneficial for miniaturization and thinning of the speaker.

The foregoing is merely illustrative of embodiments of the present invention, and it should be noted that modifications may be made to those skilled in the art without departing from the spirit of the invention but are intended to be within the scope of the invention.

What is claimed is:

1. A speaker, comprising a frame, a vibration system fixed to the frame and a magnetic circuit system;
the vibration system comprising a diaphragm fixed to the frame and a voice coil assembly driving the diaphragm to vibrate and generate sound;
the voice coil assembly comprising a first voice coil and a second voice coil arranged side by side along a first direction and located on a side of the diaphragm closer to the magnetic circuit system; wherein
the vibration system further comprises a first flexible assembly fixed to the frame and conducting the first voice coil and the second voice coil, and a second flexible assembly connecting the voice coil assembly and an external circuit; the first flexible assembly and the second flexible assembly are arranged on opposite sides of the voice coil assembly along a second direction perpendicular to the first direction;
the first direction and the second direction are both perpendicular to a vibration direction of the diaphragm,
the first flexible assembly comprises two first flexible supports arranged along the first direction and a conductive portion connecting the two first flexible supports; and
the first voice coil and the second voice coil are connected in series through the conductive portion.

2. The speaker as described in claim 1, wherein each of the two first flexible supports comprises a first elastic arm fixed to the frame, a first supporting part extending and bending from the first elastic arm toward the diaphragm, and a first lead connecting portion extending and bending from the first supporting part in a direction away from the first elastic arm and fixed to the diaphragm; the conductive portion connects the two first lead connecting portions.

3. The speaker as described in claim 1, wherein the second flexible assembly comprises two second flexible supports arranged along the first direction, each of the two second flexible supports comprises a second elastic arm fixed to the frame, a second supporting part extending and bending from the second elastic arm toward the diaphragm, and a second lead connecting portion extending and bending from the second supporting part in a direction away from the second elastic arm and fixed to the diaphragm; a solder pad for connecting the external circuit is provided on the second elastic arm.

4. The speaker as described in claim 1, wherein the magnetic circuit system comprises a lower plate, two inner magnetic circuit portions connected to the lower plate, and an outer magnetic circuit portion surrounding the two inner magnetic circuit portions; the first voice coil surrounds one of the two inner magnetic circuit portions, the second voice coil surrounds another one of the two inner magnetic circuit portions, and the two inner magnetic circuit portions and the outer magnetic circuit portion jointly form a magnetic gap for receiving the first voice coil and the second voice coil.

5. The speaker as described in claim 4, wherein each of the two inner magnetic circuit portions comprises an inner magnet fixed to the lower plate and an inner pole piece covering a side of the inner magnet away from the lower plate, and the outer magnetic circuit portion comprises an outer magnet fixed to the lower plate and an outer pole piece covering a side of the outer magnet away from the lower plate.

6. The speaker as described in claim 5, wherein the outer pole piece comprises two first sides extending along the first direction and two first protruding parts extending from the two first sides respectively in a direction away from the voice coil assembly; the two first protruding parts are fixedly connected to the frame.

7. The speaker as described in claim 5, wherein the outer magnet comprises two first outer magnetic parts extending along the first direction and arranged on opposite sides of the voice coil assembly, and two second protruding parts extending from the two first outer magnetic parts in a direction away from the voice coil assembly and fixedly bonded to the two first protruding parts.

8. The speaker as described in claim 7, wherein the lower plate comprises a lower plate body and a third protruding part extending from the lower plate body in a direction away from the inner magnetic circuit portions; the third protruding part is arranged corresponding to the second protruding part along the vibration direction of the diaphragm and is fixedly bonded to the second protruding part.

9. The speaker as described in claim 5, wherein the outer magnet further comprises two second outer magnetic parts extending along the second direction and arranged on opposite sides of the voice coil assembly, and a third outer magnetic part arranged between the two inner magnets with spacing, wherein a length d1 of the second outer magnetic part along the second direction is greater than a length d2 of the third outer magnetic part along the second direction.

10. The speaker as described in claim 6, wherein the diaphragm comprises a dome portion and a suspension surrounding the dome portion, wherein the first voice coil and the second voice coil are fixed to the dome portion, the dome portion comprises a bending part extending and bending from an outer edge of the dome portion toward the magnetic circuit system and abutting against the first flexible support, and the bending part is provided with an opening part for avoiding the first protruding part.
